(19) United States
(12) Patent Application Publication
(10) Pub. No.: US 2004/0252033 A1
(43) Pub. Date: Dec. 16, 2004

(54) Auto alarm to prevent collateral damages of an over navigable waters bridge section collapse disaster

(76) Inventor: Constantine N. Colyvas, Southampton, NY (US)

Correspondence Address: CONSTANTINE N. COLYVAS, 59 VALORIE ROAD, SOUTHAMPTON, NY, 11968, US

(21) Appl. No.: 10/459,823

(22) Filed: Jun. 11, 2003

(51) Int. Cl. G08G 1/095

(52) U.S. Cl. 340/907; 340/686.1

(57) ABSTRACT

A device that will automatically energize an Alarm Box, when an Over Navigable Water Bridge Section (ONWBS) collapses, said devise comprising two electric switches, each having two contact legs, one leg embedded steady on the base and the other leg free swinging on a pin. A spring is properly attached to keep the two legs closed, when free.

Each switch, complete with Alarm Box, is installed in a secure place at each side of the protected section of the bridge

A thin steel cable runs, through eyebolts, under the bridge, its ends connecting the free legs of the switches, and tightened enough to keep the switches electrically open.

When the ONWBS is damaged and falls, the connecting cable will brake, releasing both switches to close and energize the Alarm Boxes, that will close the bridge gates at both entries, Light up Red Flashing Lights all over the area, Blow Horns, and telephone and radio the Local Police and Coast Guard, to inform them of the accident in order to assist and avoid additional collateral accidents.

### BACKGROUND OF INVENTION

This invention relates to a device for an alarm, that will automatically be energized to act, as programmed, when the Over Navigable Waters Bridge Section (ONWBS), collapses, because that bridge's section support was knocked out, by a passing vessel, or barge, or by any other reason whatsoever.

### DESCRIPTION OF RELATED ART

We are all well aware of accidents that happened when an ONWBS was knocked down, by a passing vessel and many cars and trucks, speeding towards the bridge and unaware of the disaster ahead, drove over and fell into the water, with deadly results.

### BRIEF SUMMARY OF THE INVENTION

The device that we will describe hereunder, will completely eliminate all such collateral accidents, to any bridge collapse, by having an automatic control, immediately energizing an alarm system, on both sides of the bridge that will, among other things, close the bridges' gates at both entries to the bridge, flash Red Lights all over the area, with loud horns blowing, send telephone and radio messages to the local Police and Coast Guard, informing them of the accident and do every other thing possible to stop the bridge traffic and help in this situation.

This device is an automatic alarm system, comprising two (2) identical electrical switches, as in FIG. 1

Said switches having one leg a, embedded in the base and a second leg b free swinging on pin g.

A spring e is attached to the free end of leg b that pulls the leg and closes the electric contacts c and d , when free.

A strong back support k, part of the base, will limit leg b swinging far away from leg a, when pulled away from it.

Said switches A and B working in PAIRS, as in FIG. 2, with each switch and Alarm Box installed in a small secure place, at each end of the ONWBS.

A thin steel cable 1, of adequate strength is run, through eye bolts m secured under, or on the sides of the ONWBS, it's ends connecting the two b legs of switch A and B and tightened enough to keep switches A and B electrically open, (see FIG. 2).

Electric contacts c and d of each switch, are connected to the main electric power and to the alarm box, as shown in FIG. 1 and 2.

Said steel cable, connecting the b legs of switch A and B, should be strong enough to hold A and B switches permanently open, but having a weak point, that will brake, when excessive force brings both legs b against supports k.

It is important that said cable be run between switch A and switch B in a strait line, as much as possible.

### BRIEF DESCRIPTION OF THE DRAWINGS

FIG. 1 is a plan view of one of the two identical electric switches, having one leg (a), permanently embedded and steady and a second leg (b) swinging on pin g.

A strong back rest (k) also part of the base (h), is to stop the free swinging leg (b), when it reaches there.

A spring (e) is attached to the free swinging end of leg (b), to pull and close the electric contacts (c) and (d), when free.

An Alarm Box (f), is connected to the main electric supply, through contacts (c) and (d) of switch A which, when energized will deploy all pre-programmed kinds of alarms, both visual and audible including, close both gates of the bridge's entries, light up Red Flashing Lights, with blowing horns all over the area, telephone and radio the local police and the coast guard, informing them of the accident.

FIG. 2 is a plan view of a pair of said switches, complete with their Alarm Boxes, installed in a small secure place at each end of the ONWBS, and connected together with said steel cable (1).

### DETAILED DESCRIPTION

Normally, the steel cable will keep the two switches electrically open until, for some reason, the ONWBS is damaged and collapses, the falling section of the bridge will brake the connecting cable, the electric switches A and B will close, the Alarm Box will be energized and all pre-programmed orders will be executed, to immediately stop the bridge traffic, inform authorities etc.

### DESCRIPTION OF PRIOR ART

As far as we know, there is no prior art, that will automatically close the bridge's gates immediately, after an accident like this and advise authorities at the same time, to prevent the dreadful collateral accidents, that are so common, following a bridge's section fall.

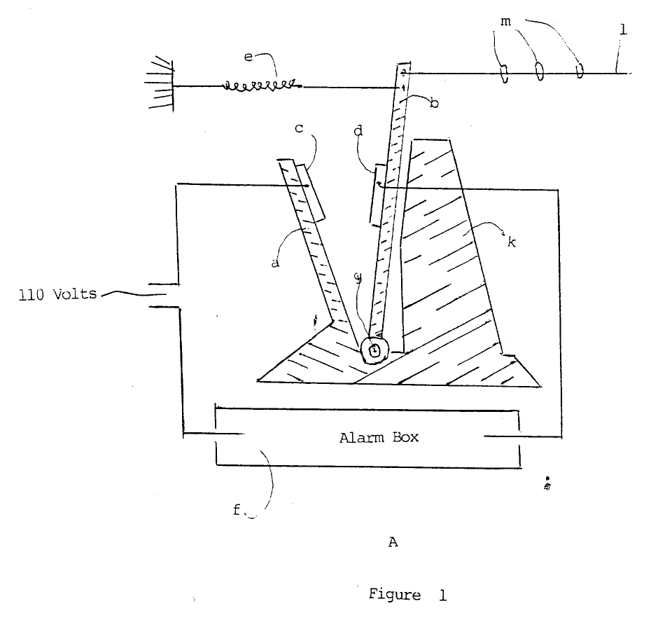

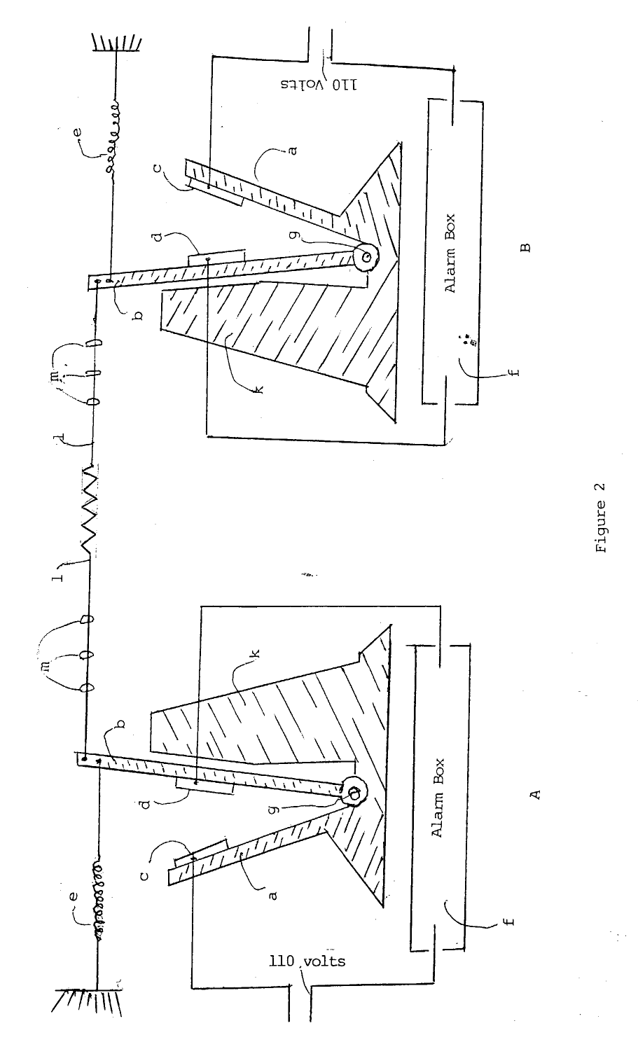

1. A device to prevent collateral damages when, the Over Navigable Waters Section of a Bridge collapses, due to the knocked off support, or other reason, and innocent speeding motorists on the road, unaware of the accident ahead, continue their speeding and fall to their deaths, comprising:
a) two identical electric switches, as in FIG. 1
b) said switch having one leg a, permanently embedded in it's base and
c) a second leg b, free swinging on pin g
d) electric contacts c, and d, on both legs are electrically connected to the main electricity and to the alarm box f,
e) said alarm box f, when energized, will close the bridges entry gates, sound alarms, light red flashing lights, dial and give messages to the local police and coast guard, informing them of the accident and do everything else necessary to immediately stop the traffic on the bridge
f) A strong back rest K, also part of the base h, is to stop the free swinging leg b, when it reaches there, by an excessive pull
g) said pair of electric switches, being installed, each one on each side of the ONWBS, in a secure place
h) said pair of switches to be kept electrically open, by a steel cable 1, each end of said cable attached to each b leg, on each switch and tightened for that purpose

2. Any other method, mechanical, electric or electronic, by which alarms automatically can be energized, when an Over Navigable Waters Bridge Section collapses for any reason, to immediately stop the bridge traffic and prevent collateral terrible accidents.
